(19) United States
(12) Patent Application Publication
(10) Pub. No.: US 2025/0306841 A1
(43) Pub. Date: Oct. 2, 2025

(54) METHOD AND APPARATUS FOR SCREEN PROJECTION, ELECTRONIC DEVICE, AND STORAGE MEDIUM

(71) Applicant: DOUYIN VISION CO., LTD., Beijing (CN)

(72) Inventors: Zhenhua Yu, Beijing (CN); Xianchao Shen, Beijing (CN)

(21) Appl. No.: 18/863,956

(22) PCT Filed: Sep. 14, 2023
(86) PCT No.: PCT/CN2023/118712

§ 371 Date: Nov. 7, 2024

(30) Foreign Application Priority Data
Sep. 26, 2022 (CN) 202211175867.1

(51) Int. Cl. G06F 3/14; H04L 65/1089; H04L 65/1093

(52) U.S. Cl. CPC G06F 3/1454; H04L 65/1089; H04L 65/1093; G06F 3/1423

(57) ABSTRACT

Embodiments of the present disclosure provide a method and apparatus for screen projection, an electronic device, and a storage medium. The method comprises detecting a current network environment of a screen projection-associated device, in a process of screen projection in a first screen projection mode. The method further comprises switching from the first screen projection mode to a second screen projection mode in response to detecting that the current network environment meets a screen projection switching condition. The method further comprises performing screen projection in the second screen projection mode.

### CROSS-REFERENCE TO RELATED APPLICATION(S)

This application claims priority to Chinese Patent Application No. 202211175867.1, filed with the China National Intellectual Property Administration on Sep. 26, 2022, the disclosure of which is incorporated herein by reference in its entirety.

### FIELD

Embodiments of the present disclosure relate to the field of computer technology, and for example, relate to a method and apparatus for screen projection, an electronic device, and a storage medium.

### BACKGROUND

The main application scenario of screen projection technology is to project the content from a small screen onto a large screen for display, which can not only enhance viewing experience of users but also facilitate simultaneous viewing by more users. Currently, the screen projection technology has been widely applied in family life and daily office work in enterprises.

In the process of implementing the present disclosure, applicant has found that, in the related art, one projection mode is manually selected for screen projection in the screen projection process. In the case of screen projection interruption or there is a need for switching, projection modes are switched through manual operation, but the process of the manual operation may cause waiting time.

### SUMMARY

The present disclosure provides a method and apparatus for screen projection, an electronic device, and a storage medium, so as to achieve automatic switching of screen projection modes in a screen projection process.

In a first aspect, an embodiment of the present disclosure provides a method for screen projection, including:
detecting a current network environment of a screen projection-associated device in a process of screen projection in a first screen projection mode:
switching from the first screen projection mode to a second screen projection mode in response to detecting that the current network environment meets a screen projection switching condition: and
performing screen projection in the second screen projection mode.

In a second aspect, an embodiment of the present disclosure further provides a screen projection apparatus, including:
a network environment detecting module, configured to detect a current network environment of a screen projection-associated device in a process of screen projection in a first screen projection mode;
a screen projection switching module, configured to switch from the first screen projection mode to a second screen projection mode in response to detecting the current network environment meets a screen projection switching condition; and
a second screen projecting module, configured to perform screen projection in the second screen projection mode.

In a third aspect, an embodiment of the present disclosure further provides an electronic device. The electronic device includes:
one or more processors; and
a storage, configured to store one or more programs,
where the one or more programs, when executed by the one or more processors, cause the one or more processors to implement the method for screen projection according to any one of the embodiments of the present disclosure.

In a fourth aspect, an embodiment of the present disclosure further provides a storage medium including computer-executable instructions, where the computer-executable instructions, when executed by a computer processor, are used to implement the method for screen projection according to any one of the embodiments of the present disclosure.

### BRIEF DESCRIPTION OF THE DRAWINGS

Throughout the accompanying drawings, the same or similar reference numerals denote the same or similar elements. It should be understood that the accompanying drawings are illustrative, and components and elements may not necessarily be drawn to scale.

FIG. 1 is a diagram of an application scenario of a method for screen projection according to an embodiment of the present disclosure;

FIG. 2 is a schematic flowchart of a method for screen projection according to an embodiment of the present disclosure;

FIG. 3 is a schematic flowchart of a method for screen projection according to an embodiment of the present disclosure;

FIG. 4 is a schematic diagram of a cloud method for screen projection according to an embodiment of the present disclosure;

FIG. 5 is a schematic diagram of a screen projection switching method according to an embodiment of the present disclosure;

FIG. 6 is a schematic flowchart of a method for screen projection according to an embodiment of the present disclosure;

FIG. 7 is a schematic diagram of a screen projection switching method according to an embodiment of the present disclosure;

FIG. 8 is a schematic diagram of a structure of a screen projection apparatus according to an embodiment of the present disclosure; and

FIG. 9 is a schematic diagram of a structure of an electronic device according to an embodiment of the present disclosure.

### DETAILED DESCRIPTION OF EMBODIMENTS

It should be understood that the plurality of steps recorded in the method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

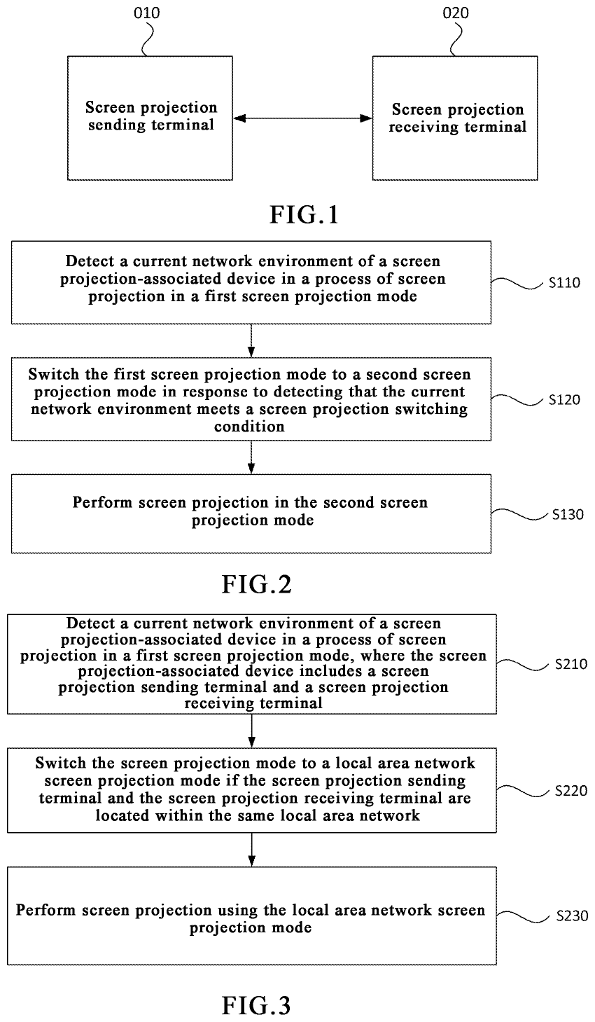

A method for screen projection provided in an embodiment of the present disclosure may be applied to an application scenario shown in FIG. 1. As shown in FIG. 1, the application scenario includes a screen projection sending terminal 010 and a screen projection receiving terminal 020. The screen projection sending terminal 010 is in communication connection with the screen projection receiving terminal 020. Both the screen projection sending terminal 010 and the screen projection receiving terminal 020 are electronic devices. The electronic devices may include, but are not limited to, a personal computer, a notebook computer, a smartphone, a tablet computer, an Internet of things device, a portable wearable device, etc. The Internet of things device may be a smart television, a smart vehicle device, etc., and the smart wearable device may be a smart watch, a head-mounted device, etc.

The screen projection sending terminal 010 is configured to send screen projection data, where the screen projection data may be prestored or generated in real time by the screen projection sending terminal, which is not limited herein. The screen projection receiving terminal 020 is configured to receive and display the screen projection data. The screen projection sending terminal 010 and the screen projection receiving terminal 020 may transmit the screen projection data through a plurality of screen projection modes. This embodiment provides a method for screen projection through which one screen projection mode is automatically switched to another screen projection mode in a screen projection process without the need for manual switching operations. It should be noted that the method for screen projection provided in this embodiment of the present disclosure may be performed by any device accessing to screen projection. In other words, the method for screen projection may be performed by the screen projection sending terminal 010 or the screen projection receiving terminal 020, which is not limited herein. Additionally, the screen projection sending terminal 010 and the screen projection receiving terminal 020 in FIG. 1 are merely examples, and the number of screen projection sending terminals 010 and screen projection receiving terminals 020 is not limited. In some embodiments, there may be a plurality of screen projection receiving terminals 020, meaning that the plurality of screen projection receiving terminals may receive and display the screen projection data.

FIG. 2 is a schematic flowchart of a method for screen projection according to an embodiment of the present disclosure. This embodiment of the present disclosure is applicable to a case of screen projection display between electronic devices. The method may be performed by a screen projection apparatus. The screen projection apparatus may be implemented in the form of software and/or hardware, and is, for example, implemented by an electronic device. The electronic device may be a mobile terminal, a personal computer (PC) terminal, a server, or the like.

As shown in FIG. 2, the method includes:

S110: Detect a current network environment of a screen projection-associated device in a process of screen projection in a first screen projection mode.

S120: Switch from the first screen projection mode to a second screen projection mode if it is detected that the current network environment meets a screen projection switching condition.

S130: Perform screen projection in the second screen projection mode.

In this embodiment, the first screen projection mode refers to a screen projection mode currently used by the screen projection-associated device. The second screen projection mode refers to a screen projection mode after switching by the screen projection-associated device. A specific screen projection mode about the first screen projection mode or the second screen projection mode is not limited herein. Exemplarily, the specific screen projection mode includes, but is not limited to, local area network screen projection and Internet screen projection, where the local area network screen projection is a screen projection mode achieved by the screen projection-associated device through the local area network, namely a screen projection mode that the screen projection-associated device transmits the screen projection data to other screen projection-associated device through the local area network; and the Internet screen projection is a screen projection mode achieved by the screen projection-associated device through the Internet, namely a screen projection mode that the screen projection-associated device transmits the screen projection data to a network server through the local area network, and the network server transmits the screen projection data to the other screen projection-associated device. For example, both the local area network screen projection and the Internet screen projection may include wired screen projection and/or wireless screen projection, where the wired screen projection may be achieved through a high definition multimedia interface (HDMI) cable; and the wireless screen projection may be wireless fidelity (WIFI) screen projection, cloud screen projection, etc. The screen projection-associated device refers to an associated electronic device capable of performing screen projection, and may include a screen projection sending terminal and a screen projection receiving terminal. There may be two or more associated electronic devices, which is not limited herein.

Exemplarily, the screen projection-associated device may include a first electronic device and a second electronic device, and the first electronic device is in communication connection with the second electronic device. The first electronic device and the second electronic device are used to distinguish one electronic device from the other electronic device. Both the first electronic device and the second electronic device are electronic devices, but are not the same electronic device. For example, the first electronic device in the present disclosure may be a mobile phone terminal, serving as the screen projection sending terminal; and the second electronic device may be a television, serving as the screen projection receiving terminal. For example, the first electronic device in the present disclosure may be a terminal device such as a computer, the second electronic device may be a terminal device such as a mobile phone and a computer, and there may be more second electronic devices.

In this embodiment, the current network environment of the screen projection-associated device refers to a network communication environment of the screen projection-associated device at a detection time of the network environment. Different network environments of the screen projection-associated device may support different screen projection modes. For example, when the screen projection-associated device has access to the local area network, the local area network screen projection mode may be supported, and when the screen projection-associated device has access to the Internet, the Internet screen projection mode may be supported, such as a cloud platform mode.

The screen projection-associated device performs screen projection through the first screen projection mode, and in the screen projection process, the current network environment of the plurality of screen projection-associated devices is detected, where the first screen projection mode may be a screen projection mode randomly selected from a plurality of screen projection modes, or a screen projection mode switched from the other screen projection mode, or a screen projection mode manually selected at a screen projection start time, which is not limited herein. Any electronic device among the screen projection-associated devices detects the current network environment of the plurality of screen projection-associated devices in the process of screen projection in the first screen projection mode. For example, the electronic device performs real-time detection on the current network environment or periodic detection on the current network environment. When it is detected that current network environment of the screen projection-associated device meets the screen projection switching condition, the screen projection mode of the screen projection-associated device is switched, where the screen projection switching condition refers to a preset condition for switching the screen projection mode of the screen projection-associated device.

It should be noted that by detecting the current network environment of the screen projection-associated device, network environment information such as a communication mode and communication quality of the screen projection-associated device may be obtained, thereby determining whether the screen projection switching condition is met based on the network environment information such as the communication mode and the communication quality of the screen projection-associated device. When the current network environment meets the screen projection switching condition, the screen projection mode may be automatically switched to a screen projection mode corresponding to the current network environment, such that the adaptability of the screen projection-associated device to the current network environment is improved, thereby ensuring the screen projection quality, unnoticeable switching is achieved, and the automatic switching is performed without interrupting the screen projection process, eliminating the need for user waiting.

Exemplarily, when the first electronic device and the second electronic device establish a connection based on the first screen projection mode, the first electronic device and/or the second electronic device may detect the current network environment, and when the current network environment meets the screen projection switching condition, a connection between the first electronic device and the second electronic device based on the second screen projection mode may be established based on the current network environment, and screen projection is performed in the second screen projection mode.

In some implementations, the second screen projection mode may be a screen projection mode determined in real time according to the current network environment. In other words, the second screen projection mode is a screen projection mode adapted to the current network environment, which can effectively improve the adaptability of the screen projection-associated device to the current network environment, thereby ensuring the screen projection quality. In some implementations, the second screen projection mode may be a fixed screen projection mode specified by the user in advance.

In some implementations, the screen projection switching condition is that a priority of the second screen projection mode supported by the current network environment is higher than a priority of the first screen projection mode.

It should be understood that a priority of the second screen projection mode supported by the current network environment is higher than a priority of the first screen projection mode, and in other words, when the screen projection-associated device performs screen projection, the second screen projection mode is preferably selected to improve the screen projection quality.

Before screen projection, the plurality of screen projection modes may be pre-configured, and priorities may be set for the plurality of screen projection modes. The basis for setting the priorities may include, but is not limited to, screen projection stability, screen projection cost, screen projection quality, screen projection speed, etc., which is not limited herein. Exemplarily, if the stability of the second screen projection mode is higher than that of the first screen projection mode, there is no display lag, and therefore the priority of the second screen projection mode is set higher than that of the first screen projection mode; or, if the screen projection cost of the second screen projection mode is lower than that of the first screen projection mode, there is no data cost, and therefore the priority of the second screen projection mode is set higher than that of the first screen projection mode; or, if the screen projection speed of the second screen projection mode is higher than that of the first screen projection mode, there is less screen projection delay, and therefore the priority of the second screen projection mode is set higher than that of the first screen projection mode. For example, the priorities of the screen projection modes may be set based on one or more of the screen projection stability, the screen projection cost, the screen projection quality, and the screen projection speed, which is not limited herein. The priorities of the screen projection modes may be updated according to user needs, and the updated priorities of the screen projection modes are stored for easy retrieval during screen projection switching.

For example, in the process of screen projection in the first screen projection mode, the screen projection-associated device may detect the current network environment of the screen projection-associated device, and the screen projection mode supported by the current network environment is determined. When a priority of the second screen projection mode supported by the current network environment is higher than a priority of the first screen projection mode, the screen projection mode may be switched to the second screen projection mode with the high priority, screen projection is performed according to the second screen projection mode, and the screen projection quality is improved. There may be a plurality of screen projection modes supported by the current network environment. When the priority is higher than the priority of the first screen projection mode, the screen projection mode with the highest priority among the screen projection modes supported by the current network environment may be determined as the second screen projection mode.

In some embodiments, the second screen projection mode may be a user-specified screen projection mode detected by the screen projection-associated device. In other words, the user-specified screen projection mode is the screen projection mode with the highest priority. It should be understood that to enhance user experience, the priority of the screen projection mode may be customized according to user needs.

In some implementations, the screen projection switching condition includes: the current network environment changing to a network environment that does not support the first screen projection mode.

It should be understood that when the communication quality of the current network environment is poor, such as communication disconnection or a slow communication transmission rate, it indicates that the current network environment cannot continue screen projection in the first screen projection mode, and the screen projection mode needs to be changed, thereby improving the screen projection quality.

For example, in the process of screen projection in the first screen projection mode, the screen projection-associated device may detect the current network environment of the screen projection-associated device, and when the current network environment does not meet the screen projection condition of the first screen projection mode, the screen projection mode may be switched to the second screen projection mode, and screen projection is performed in the second screen projection mode. The second screen projection mode may be one of the screen projection modes supported by the current network environment, such as a screen projection mode with the highest priority among the screen projection modes supported by the current network environment. It should be understood that when the current network environment does not meet the screen projection condition of the first screen projection mode, it indicates that there may be issues with the network environment needed by the first screen projection mode, and the screen projection mode in the other network environment may be adopted through replacement, thereby ensuring the screen projection quality.

Exemplarily, the current network environment may be WIFI screen projection. In the case of WIFI disconnection, the screen projection-associated device may switch to other network connections to ensure the screen projection quality. The other networks may include a cellular network, a satellite communication, etc., which are not limited herein.

It should be noted that in the case of switching to the second screen projection mode, screen projection is performed in the second screen projection mode, and the screen projection process of the first screen projection mode is stopped. The screen projection-associated device may perform screen projection according to the switched screen projection mode. For example, the screen projection sending terminal determines a screen projection data sending mode in the second screen projection mode, and sends the screen projection data. The screen projection receiving terminal determines a screen projection data receiving mode in the second screen projection mode, and receives and displays the screen projection data. A specific implementation of the second screen projection mode is not limited herein.

According to the technical solution of this embodiment of the present disclosure, in the process of screen projection in the first screen projection mode, the current network environment of the screen projection-associated device is detected. If it is detected that the current network environment meets the screen projection switching condition, the first screen projection mode is switched to the second screen projection mode, and screen projection is performed in the second screen projection mode. Through the above technical solution, the automatic switching of the screen projection modes of the screen projection-associated device is achieved, and the screen projection mode is automatically switched to the screen projection mode corresponding to the current network environment, thereby improving the adaptability of the screen projection-associated device to the current network environment.

FIG. 3 is a schematic flowchart of a method for screen projection according to an embodiment of the present disclosure. The method in this embodiment may be combined with a plurality of example solutions in the method for screen projection provided in the above embodiments. The method for screen projection provided in this embodiment is refined. For example, the second screen projection mode is the local area network screen projection mode; and the screen projection-associated device includes a screen projection sending terminal and a screen projection receiving terminal, and the screen projection switching condition includes: the screen projection sending terminal and the screen projection receiving terminal being located within the same local area network.

As shown in FIG. 3, the method includes:
S210: Detect a current network environment of a screen projection-associated device in a process of screen projection in a first screen projection mode, where the screen projection-associated device includes a screen projection sending terminal and a screen projection receiving terminal.
S220: Switch the screen projection mode to a local area network screen projection mode if the screen projection sending terminal and the screen projection receiving terminal are located within the same local arca network.
S230: Perform screen projection using the local area network screen projection mode.

In this embodiment, the screen projection sending terminal refers to an electronic device sending screen projection data. The screen projection receiving terminal refers to an electronic device receiving and displaying the screen projection data. The screen projection data may include, but is not limited to, contents such as images, audio, and videos. The local area network screen projection mode refers to a screen projection mode for screen projection display using the local area network, which may include a wired local area network screen projection mode and a wireless local area network screen projection mode. For example, the wireless local area network screen projection mode may be WIFI screen projection. It should be understood that when screen projection is performed using the local area network, the screen projection sending terminal and the screen projection receiving terminal are located within the same local area network.

For example, in the process of screen projection in the first screen projection mode, the current network environment of the screen projection sending terminal and the screen projection receiving terminal may be detected in real time, and when a detection result of the current network environment indicates that the screen projection sending terminal and the screen projection receiving terminal are located within the same local area network, the screen projection mode may be switched to the local area network screen projection mode. It should be noted that the local area network screen projection mode has the characteristics of low latency and no data consumption. By using the local area network screen projection mode for screen projection, the screen projection quality can be improved, and data consumption can be reduced. For example, the priority of the local area network screen projection mode is higher than the priority of the first screen projection mode, or the current network environment of the screen projection-associated device does not support the first screen projection mode. Exemplarily, the first screen projection mode may be a cloud screen projection mode.

In some implementations, the step of detecting a current network environment of a screen projection-associated device includes: searching for screen projection-associated device based on the local arca network; and in the case that every screen projection-associated device within the same local area network has been searched for, determining that the current network environment meets a screen projection switching condition of the local area network screen projection mode.

For example, the screen projection sending terminal searches for electronic devices located within the same local area network. If a search result includes the screen projection receiving terminal connected to the screen projection sending terminal through the first screen projection mode, it indicates that the current network environment meets the screen projection switching condition of the local area network screen projection mode. Subsequently, a local area network connection between the screen projection sending terminal and the screen projection receiving terminal may be established, and the screen projection data is transmitted through the local area network to achieve screen projection. For example, the screen projection receiving terminal searches for electronic devices located within the same local area network. If a search result includes the screen projection sending terminal connected to the screen projection receiving terminal through the first screen projection mode, it indicates that the current network environment meets the screen projection switching condition of the local area network screen projection mode. Subsequently, a local area network connection between the screen projection sending terminal and the screen projection receiving terminal may be established, and the screen projection data is transmitted through the local area network to achieve screen projection.

In some implementations, the searching for screen projection-associated device based on the local area network includes: sending a search request based on a current local area network; and receiving device information fed back by a device within the current local area network, and verifying, based on the received device information, whether the device within the current local area network is a screen projection-associated device.

The device information refers to device identifier information, and is unique. In other words, under the premise of knowing the device information of the screen projection-associated device, whether the device corresponding to the device information is the screen projection-associated device may be verified through the device information.

Exemplarily, when any electronic device among the screen projection-associated devices is connected to the local area network, the search request may be sent to the device within the current local area network. Exemplarily, the search request may be sent in the form of a broadcast and may include device information/address information of the current device, thereby facilitating information feedback from the device that receives the search request. The device within the current local area network responds to the search request and feeds back the device information to the screen projection sending terminal; and the device sending the request may verify the received device information, such as comparing the received device information with device information of a device accessed in the first screen projection mode, where if the received device information is the same as the device information of the device accessed in the first screen projection mode, the device that receives the search request within the current local area network is the screen projection-associated device, and if the received device information is different from the device information of the device accessed in the first screen projection mode, the device that receives the search request within the current local area network is not the screen projection-associated device.

In some implementations, the device information includes a device identifier and a screen projection meeting identifier. The verifying, based on the received device information, whether the device within the current local area network is a screen projection-associated device includes: comparing the screen projection meeting identifier in the device information with a screen projection meeting identifier of the current device, and matching the device identifier in the device information with a device identifier of a screen projection-associated device in the first screen projection mode; and determining that the device within the current local area network is the screen projection-associated device if the screen projection meeting identifier in the device information is the same as the screen projection meeting identifier of the current device, and the device identifier in the device information matches successfully with the device identifier of the screen projection-associated device in the first screen projection mode.

The device identifier refers to identifier information that may be used to identify a device and is unique. The device identifier may include, but is not limited to, information such as an internet protocol (IP) and a port. The screen projection meeting identifier refers to screen projection meeting identifier information that may be used for cloud screen projection. For example, the screen projection meeting identifier may be ROOM ID, and the ROOM ID may be in the form of a two-dimensional code, a text, or a character string, which is not limited herein. It should be noted that a screen projection (meeting) room may be entered using the screen projection meeting identifier, and the screen projection meeting identifier is pre-stored at a screen projection start time, where the screen projection meeting identifier stored in the screen projection-associated device accessing the same screen projection process is the same, the screen projection meeting identifier may be requested by any the screen projection-associated device, and the screen projection-associated device stores the screen projection meeting identifier through the mode of display or data transmission. It should be noted that in this embodiment, the device within the current local area network is verified through the device identifier and the screen projection meeting identifier, thereby improving reliability of verifying the screen projection-associated device.

Exemplarily, when an IP and a port received at the screen projection sending terminal are the same as an IP and a port at the screen projection receiving terminal connected through the first screen projection mode and received ROOM ID is the same as the ROOM ID previously used through the first screen projection mode, the device within the current local area network may be determined as the screen projection-associated device.

In some implementations, the searching for every screen projection-associated device within the same local area network further includes: connecting the screen projection-associated device to the local area network; and in the case of a failed connection of any screen projection-associated device, determining that the current network environment does not meet the screen projection switching condition of the local area network screen projection mode.

It should be understood that after the screen projection-associated device is determined, the screen projection-associated device may be connected to the local area network. Due to factors such as device movement and local area network signal fluctuations, the screen projection-associated device is unable to be connected to the local area network. In this case, it may be determined that the current network environment does not meet the screen projection switching condition of the local area network screen projection mode, and the screen projection mode is not switched, thereby avoiding a decrease in screen projection quality. By connecting the screen projection-associated device to the local area network, it is guaranteed that the screen projection mode is smoothly switched to the local area network screen projection mode, and normal screen projection may be performed in the local area network screen projection mode.

In some implementations, the first screen projection mode is a cloud screen projection mode. Determining a second screen projection mode corresponding to the current network environment includes: leaving a screen projection room of the cloud screen projection and sending a local area network screen projection instruction to the screen projection-associated device, such that the screen projection-associated device receives the local area network screen projection instruction and leaves the screen projection room of the cloud screen projection.

In this embodiment, the cloud screen projection mode refers to a screen projection mode that utilizes a wide area network or the Internet for screen projection display. Compared with the local area network, the wide area network or the Internet has a wider communication range, thereby allowing for a richer variety of application scenarios for the method for screen projection. In the cloud screen projection mode, screen projection may be achieved through any network, but the cloud screen projection mode has high latency and incurs upstream and downstream data usage charges. It should be understood that the screen projection sending terminal and the screen projection receiving terminal cannot connect to the same local area network, or when one of the screen projection sending terminal and the screen projection receiving terminal has poor local area network signals, the cloud screen projection mode may be used as an alternative screen projection mode, thereby ensuring the screen projection quality.

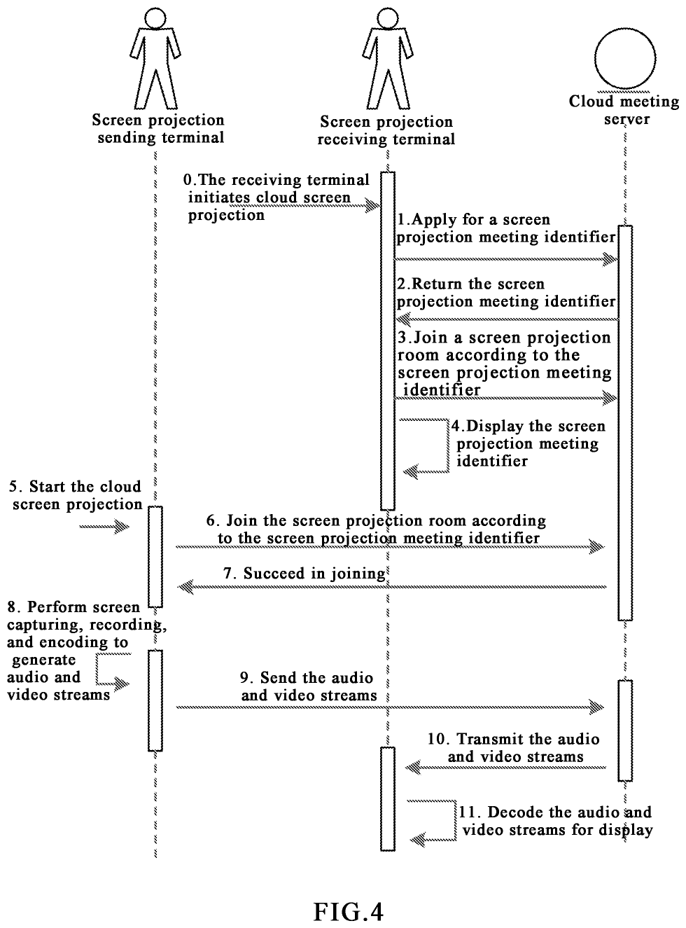

Exemplarily, FIG. 4 is a schematic diagram of a cloud method for screen projection according to an embodiment of the present disclosure. The cloud method for screen projection includes the steps: 0: a screen projection receiving terminal starting cloud screen projection; 1: the screen projection receiving terminal applying for a screen projection meeting identifier (ROOM ID) from a cloud mecting server, where the screen projection meeting identifier may be a PIN code or a two-dimensional code; 2: the cloud meeting server returning the screen projection meeting identifier to the screen projection receiving terminal; 3: the screen projection receiving terminal joining a screen projection room according to the screen projection mecting identifier; 4: the screen projection receiving terminal displaying the screen projection meeting identifier; 5: a screen projection sending terminal starting the cloud screen projection; 6: the screen projection sending terminal joining the screen projection room by scanning or inputting the screen projection meeting identifier; 7: the cloud meeting server returning a successful join result to the screen projection sending terminal; 8: the screen projection sending terminal performing screen capturing, recording, and encoding to generate audio and video streams; 9: the screen projection sending terminal sending the audio and video streams to the cloud meeting server; 10: the cloud meeting server transmitting the audio and video streams to the screen projection receiving terminal; and 11: the screen projection receiving terminal decoding the audio and video streams for display.

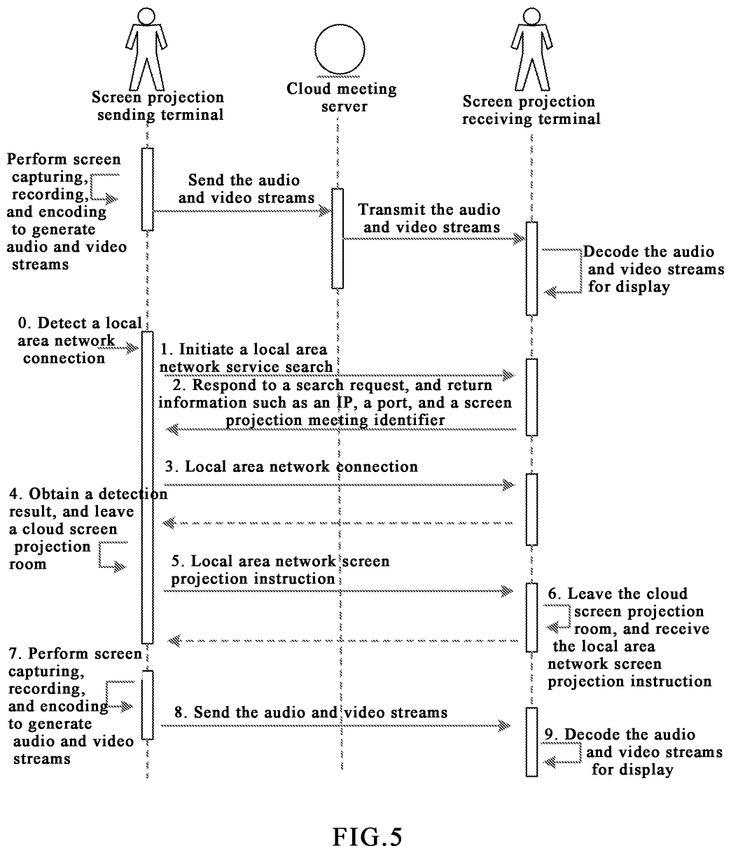

FIG. 5 is a schematic diagram of a screen projection switching method according to an embodiment of the present disclosure. In FIG. 5, the cloud screen projection mode is switched to the local area network screen projection mode. In the process of screen projection using the cloud screen projection mode, the screen projection switching method includes the steps: 0: a screen projection sending terminal detecting the availability of a local area network connection; 1: the screen projection sending terminal initiating a local arca network service search, and sending a search request; 2: a screen projection receiving terminal responding to the search request, and returning information such as an IP, a port, and a screen projection meeting identifier of the screen projection receiving terminal; 3: the screen projection sending terminal initiating the local arca network connection to the screen projection receiving terminal; 4: the screen projection sending terminal detecting a local area network connection result, and leaving a cloud screen projection room; 5: the screen projection sending terminal sending a local area network screen projection instruction to the screen projection receiving terminal; 6: the screen projection receiving terminal leaving the cloud screen projection room, and receiving the local area network screen projection instruction; 7: the screen projection sending terminal performing screen capturing, recording, and encoding to generate audio and video streams; 8: the screen projection sending terminal sending the audio and video streams to the screen projection receiving terminal; and 9: the screen projection receiving terminal decoding the audio and video streams for display.

In the technical solution of this embodiment of the present disclosure, if the screen projection sending terminal and the screen projection receiving terminal are located within the same local area network, the screen projection mode is switched to the local area network screen projection mode, and screen projection is performed according to the local area network screen projection mode, thereby improving the screen projection quality.

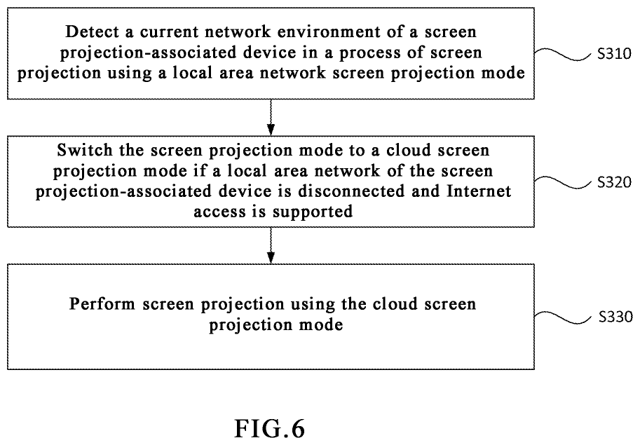

FIG. 6 is a schematic flowchart of a method for screen projection according to an embodiment of the present disclosure. The method in this embodiment may be combined with a plurality of example solutions in the method for screen projection provided in the above embodiments. The method for screen projection provided in this embodiment is refined. For example, the first screen projection mode is a local area network screen projection mode, and the second screen projection mode is a cloud screen projection mode; and a screen projection switching condition of the cloud screen projection mode includes: the screen projection-associated device disconnecting from the local area network and supporting Internet access.

As shown in FIG. 6, the method includes:
S310: Detect a current network environment of a screen projection-associated device in a process of screen projection using the local area network screen projection mode.
S320: Switch the screen projection mode to the cloud screen projection mode if the local area network of the screen projection-associated device is disconnected, and Internet access is supported.
S330: Perform screen projection using the cloud screen projection mode.

In this embodiment, the local area network disconnection refers to the screen projection-associated device disconnecting from the local area network. It should be understood that in the case of the screen projection-associated device disconnecting from the local area network and supporting the Internet access, the screen projection mode is switched to the cloud screen projection mode, thereby avoiding interruption of screen projection, and ensuring the continuity of images displayed through screen projection.

In some implementations, the screen projection-associated device pre-stores the screen projection meeting identifier of the cloud screen projection mode; and the determining a second screen projection mode corresponding to the current network environment includes: joining a screen projection meeting room in the cloud screen projection mode based on the screen projection meeting identifier.

It should be understood that each screen projection-associated device pre-stores the screen projection meeting identifier of the cloud screen projection mode, and it may be ensured that after the local area network is disconnected, there is a basis for the switching the screen projection mode, and the devices join the same screen projection meeting room, thereby enhancing the screen projection mode switching speed and screen projection connection accuracy.

In some implementations, the screen projection meeting identifier is determined by: sending, by any device accessing screen projection, a meeting application to the cloud meeting server, and receiving, by the any device accessing screen projection, a screen projection meeting identifier fed back by the cloud meecting server; and displaying, by any device accessing screen projection, the screen projection meeting identifier or sending, by the any device accessing screen projection, the screen projection meeting identifier to other device accessing the screen projection.

Exemplarily, when the screen projection-associated devices perform screen projection in the local area network screen projection mode, any one of the screen projection-associated devices may send the meeting application to the cloud meeting server, the cloud meeting server feeds back the screen projection meeting identifier to more of the screen projection-associated devices, and the more of the screen projection-associated devices locally store the screen projection meeting identifier, such that when the local area network is disconnected, the screen projection-associated devices join the screen projection meeting room according to the screen projection meeting identifier, thereby achieving seamless switching of screen projection, and ensuring the continuity of images displayed through screen projection. Meanwhile, the process does not require user participation, thereby enhancing user experience.

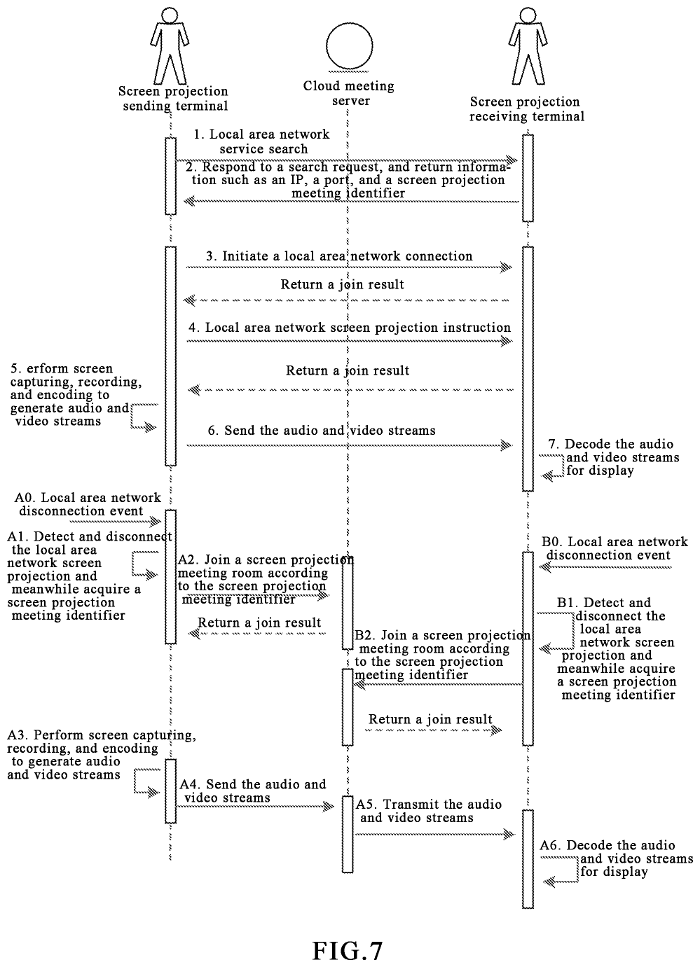

Exemplarily, FIG. 7 is a schematic diagram of a screen projection switching method according to an embodiment of the present disclosure. The screen projection switching method includes the steps: 1: a screen projection sending terminal initiating a local area network service search; 2: a screen projection receiving terminal responding to a search request, and returning information such as an IP, a port, and a screen projection mecting identifier; 3: the screen projection sending terminal initiating a local area network connection to the screen projection receiving terminal, and the screen projection receiving terminal returning a join result; 4: the screen projection sending terminal sending a local area network screen projection instruction to the screen projection receiving terminal, and the screen projection receiving terminal returning a join result; 5: the screen projection sending terminal performing screen capturing, recording, and encoding to generate audio and video streams; 8: the screen projection sending terminal sending the audio and video streams to the screen projection receiving terminal; and 9: the screen projection receiving terminal decoding the audio and video streams for display. For example, A0: the screen projection sending terminal detects a local area network disconnection event; A1: the screen projection sending terminal performs detection, disconnects the local area network screen projection, and acquires a screen projection meeting identifier; A2: the screen projection sending terminal joins a screen projection meeting room according to the screen projection meeting identifier, and the cloud meeting server returns a join result to the screen projection sending terminal; B0: the screen projection receiving terminal detects a local area network disconnection event; B1: the screen projection receiving terminal performs detection, disconnects the local area network screen projection, and acquires a screen projection meeting identifier; B2: the screen projection receiving terminal joins a screen projection meeting room according to the screen projection meeting identifier, and the cloud meeting server returns a join result to the screen projection receiving terminal; A3: the screen projection sending terminal performs screen capturing, recording, and encoding to generate audio and video streams; A4: the screen projection sending terminal sends the audio and video streams to the cloud mecting server; A5: the cloud meeting server transmits the audio and video streams to the screen projection receiving terminal; and A6: the screen projection receiving terminal decodes the audio and video streams for display.

According to the technical solution of this embodiment of the present disclosure, in the case of the screen projection-associated device disconnecting from the local area network and supporting the Internet access, the screen projection mode is switched to the cloud screen projection mode, thereby avoiding interruption of screen projection, and ensuring the continuity of images displayed through screen projection.

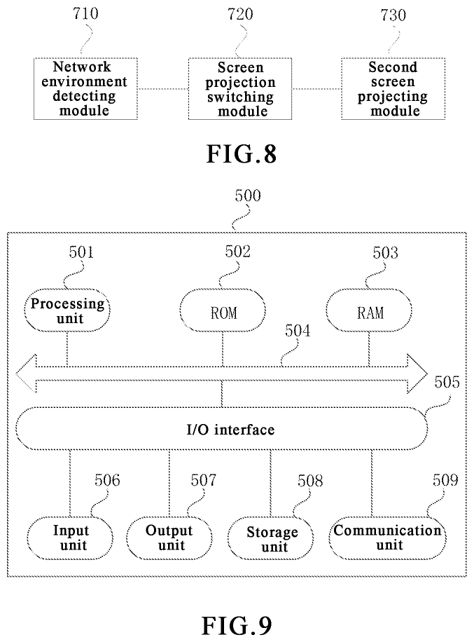

FIG. 8 is a schematic diagram of a structure of a screen projection apparatus according to an embodiment of the present disclosure. As shown in FIG. 8, the apparatus includes: a network environment detecting module 710, a screen projection switching module 720, and a second screen projecting module 730.

The network environment detecting module 710 is configured to detect a current network environment of a screen projection-associated device in a process of screen projection in a first screen projection mode;
the screen projection switching module 720 is configured to switch from the first screen projection mode to a second screen projection mode if it is detected that the current network environment meets a screen projection switching condition; and
the second screen projecting module 730 is configured to perform screen projection in the second screen projection mode.

According to the technical solution of this embodiment of the present disclosure, in the process of screen projection in the first screen projection mode, the current network environment of the screen projection-associated device is detected. If it is detected that the current network environment mects the screen projection switching condition, the first screen projection mode is switched to the second screen projection mode, and screen projection is performed in the second screen projection mode. Through the above technical solution, the automatic switching of the screen projection modes of the screen projection-associated device is achieved, and the screen projection mode is automatically switched to the screen projection mode corresponding to the current network environment, thereby improving the adaptability of the screen projection-associated device to the current network environment.

In some implementations, the screen projection switching condition is that a priority of the second screen projection mode supported by the current network environment is higher than a priority of the first screen projection mode.

In some implementations, the screen projection switching condition includes: the current network environment changing to a network environment that does not support the first screen projection mode.

In some implementations, the second screen projection mode is a local area network screen projection mode.

The screen projection-associated device includes a screen projection sending terminal and a screen projection receiving terminal, and the screen projection switching condition includes: the screen projection sending terminal and the screen projection receiving terminal being located within the same local area network.

In some implementations, the network environment detecting module 710 includes:
a screen projection-associated device search unit, configured to search for screen projection-associated device based on the local area network; and
a screen projection switching condition determination unit, configured to determine, in the case that every screen projection-associated device within the same local area network has been searched for, that the current network environment meets a screen projection switching condition of the local area network screen projection mode.

In some implementations, the screen projection-associated device search unit includes:
a search request sending subunit, configured to send a search request based on the current local area network; and
an information verifying subunit, configured to receive device information fed back by a device within the current local area network, and verify, based on the received device information, whether the device within the current local area network is a screen projection-associated device.

In some implementations, the device information includes a device identifier and a screen projection meeting identifier; and the information verifying subunit is configured to:
compare the screen projection meeting identifier in the device information with a screen projection meeting identifier of the current device, and match the device identifier in the device information with a device identifier of a screen projection-associated device in the first screen projection mode; and
determine that the device within the current local area network is the screen projection-associated device if the screen projection meeting identifier in the device information is the same as the screen projection meeting identifier of the current device, and the device identifier in the device information matches successfully with the device identifier of the screen projection-associated device in the first screen projection mode.

In some implementations, the screen projection switching condition determination unit is further configured to:
connect the screen projection-associated device to the local area network; and
determine that the current network environment does not meet the screen projection switching condition of the local area network screen projection mode in the case of a failed connection of any screen projection-associated device.

In some implementations, the first screen projection mode is a cloud screen projection mode; and the screen projection switching module 720 is configured to:
leave a screen projection room of cloud screen projection and send a local area network screen projection instruction to the screen projection-associated device, such that the screen projection-associated device receives the local area network screen projection instruction and leaves the screen projection room of the cloud screen projection.

In some implementations, the first screen projection mode is a local area network screen projection mode, and the second screen projection mode is a cloud screen projection mode; and
a screen projection switching condition of the cloud screen projection mode includes: the screen projection-associated device disconnecting from the local area network and supporting Internet access.

In some implementations, the screen projection-associated device pre-stores a screen projection meeting identifier of the cloud screen projection mode; and the screen projection switching module 720 is further configured to:
join a screen projection meeting room in the cloud screen projection mode based on the screen projection meeting identifier.

In some implementations, the screen projection meeting identifier is determined by:
sending, by any device accessing screen projection, a meeting application to a cloud meeting server, receiving by the any device accessing screen projection, a screen projection meeting identifier fed back by the cloud meeting server, and displaying the screen projection meeting identifier or sending by the any device accessing screen projection, the screen projection meeting identifier to other device accessing the screen projection.

The screen projection apparatus provided in this embodiment of the present disclosure may perform the method for screen projection provided in any embodiment of the present disclosure, and has the corresponding functional modules and beneficial effects for performing the method for screen projection.

It should be noted that the plurality of units and modules included in the above apparatus are only divided according to functional logics, but are not limited to the above division, as long as the corresponding functions can be achieved; and in addition, the specific names of the plurality of functional units are only for the convenience of distinguishing each other, and are not intended to limit the scope of protection of the embodiments of the present disclosure.

FIG. 9 is a schematic diagram of a structure of an electronic device according to an embodiment of the present disclosure. Reference is made to FIG. 9 below, which is a schematic diagram of a structure of an electronic device (e.g., a terminal device or a server in FIG. 9) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 9 is merely an example, and should not impose any limitation on the function and scope of use of the embodiments of the present disclosure.

As shown in FIG. 9. the electronic device 500 may include a processing unit (e.g., a central processing unit and a graphics processing unit) 501, which may perform various appropriate actions and processing according to a program stored on a read-only memory (ROM) 502 or a program loaded from a storage unit 508 into a random access memory (RAM) 503. The RAM 503 further stores various programs and data required for the operation of the electronic device 500. The processing unit 501, the ROM 502, and the RAM 503 are connected to one another through a bus 504. An input/output (I/O) interface 505 is also connected to the bus 504.

Typically, the following apparatuses may be connected to the I/O interface 505: an input unit 506, including, for example, a touchscreen, a touchpad, a keyboard, a mouse, a camera, a microphone, an accelerometer, and a gyroscope; an output unit 507, including, for example, a liquid crystal display (LCD), a speaker, and a vibrator; the storage unit 508, including, for example, a magnetic tape and a hard drive; and a communication unit 509. The communication unit 509 may allow the electronic device 500 to be in wireless or wired communication with other devices for data exchange. Although FIG. 9 illustrates the electronic device 500 with various apparatuses, it should be understood that it is not necessary to implement or have all the shown apparatuses. It may be an alternative to implement or have more or fewer apparatuses.

According to this embodiment of the present disclosure, the foregoing process described with reference to the flowchart may be implemented as a computer software program. For example. an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication unit 509, or installed from the storage unit 508, or installed from the ROM 502. The computer program, when executed by the processing unit 501, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the method for screen projection provided in the above embodiment belong to the same concept, and for technical details not described in detail in this embodiment, reference may be made to the above embodiment. This embodiment and the above embodiment have the same beneficial effects.

An embodiment of the present disclosure provides a computer storage medium, storing a computer program. The program, when executed by a processor, implements the method for screen projection provided in the above embodiment.

It should be noted that the above computer-readable medium described in the present disclosure may be a computer-readable signal medium, or a computer-readable storage medium, or any combination of the above. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an crasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be used by or in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program used by or in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The computer-readable medium may be included in the above electronic device; or may also separately exist without being assembled in the electronic device.

The computer-readable medium carries one or more programs. The one or more programs, when executed by the electronic device, cause the electronic device to:

The computer-readable medium carries one or more programs. The one or more programs, when executed by the electronic device, cause the electronic device to: detect a current network environment of a screen projection-associated device in a process of screen projection in a first screen projection mode; switch from the first screen projection mode to a second screen projection mode if it is detected that the current network environment meets a screen projection switching condition; and perform screen projection in the second screen projection mode.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the unit does not limit the unit itself in certain cases.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, [Example 1] provides a method for screen projection, including:
detecting a current network environment of a screen projection-associated device in a process of screen projection in a first screen projection mode;
switching from the first screen projection mode to a second screen projection mode if it is detected that the current network environment meets a screen projection switching condition; and
performing screen projection in the second screen projection mode.

According to one or more embodiments of the present disclosure, [Example 2] provides a method for screen projection, where the screen projection switching condition is that a priority of the second screen projection mode supported by the current network environment is higher than a priority of the first screen projection mode.

According to one or more embodiments of the present disclosure, [Example 3] provides a method for screen projection, where
the screen projection switching condition includes: the current network environment changing to a network environment that does not support the first screen projection mode.

According to one or more embodiments of the present disclosure, [Example 4] provides a method for screen projection, where
the second screen projection mode is a local area network screen projection mode; and
the screen projection-associated device includes a screen projection sending terminal and a screen projection receiving terminal, and the screen projection switching condition includes: the screen projection sending terminal and the screen projection receiving terminal being located within the same local area network.

According to one or more embodiments of the present disclosure, [Example 5] provides a method for screen projection, where
the detecting a current network environment of a screen projection-associated device includes:
searching for screen projection-associated device based on the local area network; and
determining, in the case that every screen projection-associated device within the same local area network has been searched for, that the current network environment meets a screen projection switching condition of the local area network screen projection mode.

According to one or more embodiments of the present disclosure, [Example 6] provides a method for screen projection, where
the searching for screen projection-associated device based on the local area network includes:
sending a search request based on a current local area network; and
receiving device information fed back by a device within the current local area network, and verifying, based on the received device information, whether the device within the current local area network is a screen projection-associated device.

According to one or more embodiments of the present disclosure, [Example 7] provides a method for screen projection, where
the device information includes a device identifier and a screen projection meeting identifier; and
the verifying, based on the received device information, whether the device within the current local area network is a screen projection-associated device includes:
comparing the screen projection meeting identifier in the device information with a screen projection meeting identifier of the current device, and matching the device identifier in the device information with a device identifier of a screen projection-associated device in the first screen projection mode; and
determining that the device within the current local area network is the screen projection-associated device if the screen projection meeting identifier in the device information is the same as the screen projection meeting identifier of the current device, and the device identifier in the device information matches successfully with the device identifier of the screen projection-associated device in the first screen projection mode.

According to one or more embodiments of the present disclosure, [Example 8] provides a method for screen projection, where
in the case that every screen projection-associated device within the same local area network has been searched for, the method further includes:
connecting the screen projection-associated device to the local area network; and
determining that the current network environment does not meet the screen projection switching condition of the local area network screen projection mode in the case of a failed connection of any screen projection-associated device.

According to one or more embodiments of the present disclosure, [Example 9] provides a method for screen projection, where
the first screen projection mode is a cloud screen projection mode; and
the switching from the first screen projection mode to a second screen projection mode includes:
leaving a screen projection room of cloud screen projection and sending a local area network screen projection instruction to the screen projection-associated device, such that the screen projection-associated device receives the local area network screen projection instruction and leaves the screen projection room of the cloud screen projection.

According to one or more embodiments of the present disclosure, [Example 10] provides a method for screen projection, where
the first screen projection mode is a local area network screen projection mode, and a second screen projection mode is the cloud screen projection mode; and
a screen projection switching condition of the cloud screen projection mode includes: the screen projection-associated device disconnecting from the local area network and supporting Internet access.

According to one or more embodiments of the present disclosure, [Example 11] provides a method for screen projection, where
the screen projection-associated device pre-stores the screen projection meeting identifier of the cloud screen projection mode; and
the determining a second screen projection mode corresponding to the current network environment includes:
joining a screen projection meeting room in the cloud screen projection mode based on the screen projection meeting identifier.

According to one or more embodiments of the present disclosure, [Example 12] provides a method for screen projection, where
the screen projection meeting identifier is determined by;
sending, by any device accessing screen projection, a meeting application to a cloud meeting server, receiving, by the any device accessing screen projection, a screen projection meeting identifier fed back by the cloud meeting server, and displaying the screen projection meeting identifier or sending, by the any device accessing screen projection, the screen projection meeting identifier to other device accessing the screen projection.

According to one or more embodiments of the present disclosure, [Example 13] provides a screen projection apparatus, including;
a network environment detecting module, configured to detect a current network environment of a screen projection-associated device in a process of screen projection in a first screen projection mode;
a screen projection switching module, configured to switch from the first screen projection mode to a second screen projection mode if it is detected that the current network environment meets a screen projection switching condition; and
a second screen projecting module, configured to perform screen projection in the second screen projection mode.

Further, although a plurality of operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments separately or in any suitable subcombination.

1. A method for screen projection, comprising;
detecting a current network environment of a screen projection-associated device, in a process of screen projection in a first screen projection mode;
switching from the first screen projection mode to a second screen projection mode in response to detecting that the current network environment meets a screen projection switching condition; and
performing screen projection in the second screen projection mode.

2. The method of claim 1, wherein the screen projection switching condition is that a priority of the second screen projection mode supported by the current network environment is higher than a priority of the first screen projection mode.

3. The method of claim 1, wherein the screen projection switching condition comprises: the current network environment changing to a network environment that does not support the first screen projection mode.

4. The method of claim 1, wherein the second screen projection mode is a local area network screen projection mode; and
the screen projection-associated device comprises a screen projection sending terminal and a screen projection receiving terminal, and the screen projection switching condition comprises: the screen projection sending terminal and the screen projection receiving terminal being located within a same local area network.

5. The method of claim 4, wherein detecting the current network environment of the screen projection-associated device comprises:
searching for the screen projection-associated device based on the local area network; and
in the case that every screen projection-associated device within the same local area network has been searched for, determining that the current network environment meets a screen projection switching condition for the local area network screen projection mode.

6. The method of claim 5, wherein searching for the screen projection-associated device based on the local area network comprises:
sending a search request based on a current local area network; and
receiving device information fed back by a device within the current local area network, and verifying, based on the received device information, whether the device within the current local area network is a screen projection-associated device.

7. The method of claim 6, wherein the device information comprises a device identifier and a screen projection meeting identifier; and
wherein verifying, based on the received device information, whether the device within the current local area network is the screen projection-associated device comprises:
comparing the screen projection meeting identifier in the device information with a screen projection meeting identifier of current device, and matching the device identifier in the device information with a device identifier of a screen projection-associated device in the first screen projection mode; and
determining that the device within the current local area network is a screen projection-associated device, in response to determining that the screen projection meeting identifier in the device information is the same as the screen projection meeting identifier of the current device, and that the device identifier in the device information matches successfully with the device identifier of the screen projection-associated device in the first screen projection mode.

8. The method of claim 5, wherein the method further comprises, in the case that every screen projection-associated device within the same local area network has been searched for:
connecting the screen projection-associated device to the local area network; and
determining that the current network environment does not meet the screen projection switching condition for the local area network screen projection mode in the case of a failed connection of any screen projection-associated device.

9. The method of claim 4, wherein the first screen projection mode is a cloud screen projection mode; and
wherein switching from the first screen projection mode to the second screen projection mode comprises:
leaving a screen projection room by cloud screen projection and sending a local area network screen projection instruction to the screen projection-associated device, such that the screen projection-associated device receives the local area network screen projection instruction and leaves the screen projection room by the cloud screen projection.

10. The method of claim 1, wherein the first screen projection mode is a local area network screen projection mode, and the second screen projection mode is a cloud screen projection mode; and
wherein a screen projection switching condition for the cloud screen projection mode comprises: a screen projection-associated device disconnecting from the local area network and supporting Internet access.

11. The method of claim 10, wherein the screen projection-associated device pre-stores a screen projection meeting identifier of the cloud screen projection mode; and
wherein the second screen projection mode is determined by:
joining a screen projection meeting room in the cloud screen projection mode based on the screen projection meeting identifier.

12. The method of claim 11, wherein the screen projection meeting identifier is determined by:
sending, by any device accessing screen projection, a meeting application to a cloud meeting server, and receiving, by the any device accessing screen projection, a screen projection meeting identifier fed back by the cloud meeting server; and
displaying, by any device accessing screen projection, the screen projection meeting identifier, or sending, by the any device accessing screen projection and to other device accessing the screen projection, the screen projection meeting identifier.

13. (canceled)

14. An electronic device, comprising:
one or more processors; and
a storage, configured to store one or more programs,
wherein the one or more programs, when executed by the one or more processors, cause the one or more processors to:
detect a current network environment of a screen projection-associated device, in a process of screen projection in a first screen projection mode;
switch from the first screen projection mode to a second screen projection mode in response to detecting that the current network environment meets a screen projection switching condition; and
perform screen projection in the second screen projection mode.

15. A non-transitory storage medium comprising computer-executable instructions, wherein the computer-executable instructions, when executed by a computer processor, cause the computer processor to:
detect a current network environment of a screen projection-associated device, in a process of screen projection in a first screen projection mode;
switch from the first screen projection mode to a second screen projection mode in response to detecting that the current network environment meets a screen projection switching condition; and
perform screen projection in the second screen projection mode.

16. The electronic device of claim 14, wherein the second screen projection mode is a local area network screen projection mode; and
the screen projection-associated device comprises a screen projection sending terminal and a screen projection receiving terminal, and the screen projection switching condition comprises: the screen projection sending terminal and the screen projection receiving terminal being located within a same local area network.

17. The electronic device of claim 14, wherein the first screen projection mode is a cloud screen projection mode; and
wherein switching from the first screen projection mode to the second screen projection mode comprises:
leaving a screen projection room by cloud screen projection and sending a local area network screen projection instruction to the screen projection-associated device, such that the screen projection-associated device receives the local area network screen projection instruction and leaves the screen projection room by the cloud screen projection.

18. The electronic device of claim 14, wherein the first screen projection mode is a local area network screen projection mode, and the second screen projection mode is a cloud screen projection mode; and
wherein a screen projection switching condition for the cloud screen projection mode comprises: a screen projection-associated device disconnecting from the local area network and supporting Internet access.

19. The non-transitory storage medium of claim 15, wherein the first screen projection mode is a cloud screen projection mode; and
wherein switching from the first screen projection mode to the second screen projection mode comprises:
leaving a screen projection room by cloud screen projection and sending a local area network screen projection instruction to the screen projection-associated device, such that the screen projection-associated device receives the local area network screen projection instruction and leaves the screen projection room by the cloud screen projection.

20. The non-transitory storage medium of claim 15, wherein the first screen projection mode is a cloud screen projection mode; and
wherein switching from the first screen projection mode to the second screen projection mode comprises:
leaving a screen projection room by cloud screen projection and sending a local area network screen projection instruction to the screen projection-associated device, such that the screen projection-associated device receives the local area network screen projection instruction and leaves the screen projection room by the cloud screen projection.

21. The non-transitory storage medium of claim 15, wherein the first screen projection mode is a local area network screen projection mode, and the second screen projection mode is a cloud screen projection mode; and
wherein a screen projection switching condition for the cloud screen projection mode comprises: a screen projection-associated device disconnecting from the local area network and supporting Internet access.
